(19) United States
(12) Patent Application Publication
(10) Pub. No.: US 2015/0193731 A1
(43) Pub. Date: Jul. 9, 2015

(54) PROVIDING OPTIMIZED DELIVERY LOCATIONS FOR AN ORDER

(71) Applicant: INTERNATIONAL BUSINESS MACHINES CORPORATION, Armonk, NY (US)

(72) Inventors: Mark B. Stevens, Austin, TX (US); John D. Wilson, Houston, TX (US)

(21) Appl. No.: 14/486,798

(22) Filed: Sep. 15, 2014

Related U.S. Application Data
(63) Continuation of application No. 14/147,897, filed on Jan. 6, 2014.

(51) Int. Cl. G06Q 10/08; G06Q 30/06

(52) U.S. Cl. CPC G06Q 10/0836; G06Q 30/0631; G06Q 30/0635; G06Q 10/08355

(57) ABSTRACT

A method for recommending a delivery locker based on user convenience and delivery cost including receiving a request to deliver an item to a user; analyzing user activity information to identify a user route including expected timing; analyzing the item for storage requirements to identify lockers meeting the requirements which are navigationally proximate to the user route; ranking the identified lockers with a ranking based on criteria; and presenting an ordering of the identified lockers based on the ranking for user selection.

This application is a continuation of application Ser. No. 14/147,897 filed Jan. 6, 2014 entitled “PROVIDING OPTIMIZED DELIVERY LOCATIONS FOR AN ORDER”, the disclosure of which is incorporated in its entirety herein by reference.

### BACKGROUND

1. Technical Field

The present invention relates generally to providing an optimized set of delivery locations for an order, and in particular, to a computer implemented method for providing an optimized set of locker locations for an order taking into account cost and convenience.

2. Description of Related Art

Today consumers can purchase many types of goods and services on-line. When ordered, the ordered items can be delivered directly to their home, office or other user designated location. The ordered items can include a wide variety of products including books, appliances, pet supplies, medicines, etc. The variety of goods and services available for order on-line is increasing every year and providing strong competition with traditional businesses.

Users are expecting quicker delivery of these products at an expected delivery time and at low cost. However, these can be security and other issues with such deliveries. This has created the need for companies to be very flexible in their product offerings as well as delivery times and locations.

### SUMMARY

The illustrative embodiments provide a method for recommending a delivery locker based on user convenience and delivery cost including receiving a request to deliver an item to a user; analyzing user activity information to identify a user route including expected timing; analyzing the item for storage requirements to identify lockers meeting the requirements which are navigationally proximate to the user route; ranking the identified lockers with a ranking based on criteria; and presenting an ordering of the identified lockers based on the ranking for user selection.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of an illustrative data processing system in which various embodiments of the present disclosure may be implemented;

FIG. 2 is a block diagram of an illustrative network of data processing systems in which various embodiments of the present disclosure may be implemented;

FIG. 3 is a block diagram of a delivery location optimizer system in which various embodiments may be implemented;

FIG. 4A is a diagram of a customer route and delivery vehicle routes in which various embodiments may be implemented;

FIG. 4B is a diagram of a user interface for displaying and choosing from the ranked delivery locations in which various embodiments may be implemented;

FIG. 5 is a flow diagram of providing delivery location recommendations in accordance with a preferred embodiment;

FIG. 6 is a flow diagram of handling unclaimed items in which various embodiments may be implemented; and

FIGS. 7A through 7E are block diagrams of types of database records in which various embodiments may be implemented.

### DETAILED DESCRIPTION

Processes and devices may be implemented and utilized for providing an optimized set of delivery locations for an order. These processes and apparatuses may be implemented and utilized as will be explained with reference to the various embodiments below.

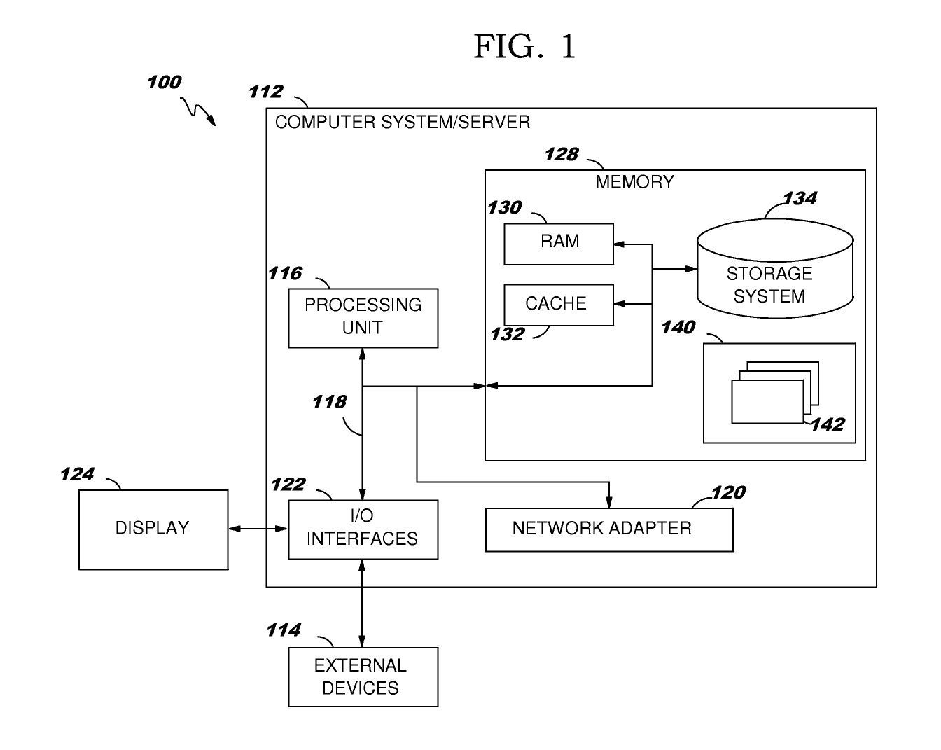

FIG. 1 is a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as providing an optimized set of delivery locations for an order.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system readable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for providing an optimized set of delivery locations for an order.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

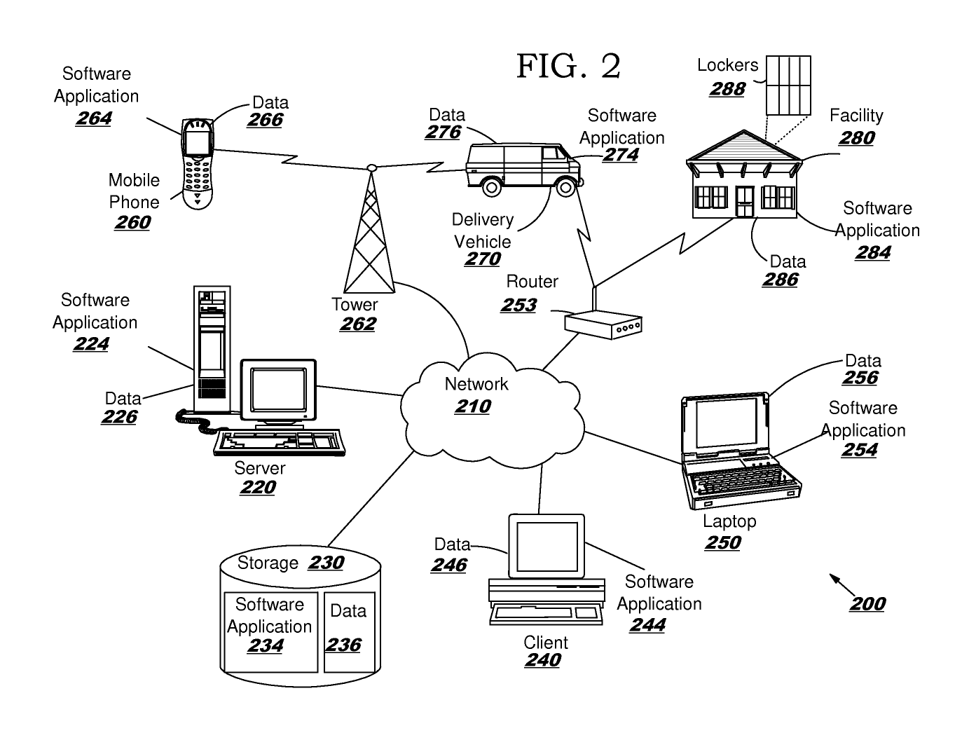

FIG. 2 is a block diagram of an illustrative network of data processing systems in which various embodiments of the present disclosure may be implemented. Data processing environment 200 is a network of data processing systems such as described above with reference to FIG. 1. Software applications such as for providing an optimized set of delivery locations for an order may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250, delivery vehicle 270 and facility 280 (such as a home or business) are coupled to network 210 including wirelessly such as through a network router 253. A mobile phone 260 and delivery vehicle 270 may be coupled to network 210 through a mobile phone tower 262. Data processing systems, such as server 220, client 240, laptop 250, mobile phone 260, delivery vehicle 270 and facility 280 contain data and have software applications including software tools executing thereon. Other types of data processing systems such as personal digital assistants (PDAs), smartphones, tablets and netbooks may be coupled to network 210.

Server 220 may include software application 224 and data 226 for providing an optimized set of delivery locations including lockers 288 for an order or other software applications and data in accordance with embodiments described herein. Storage 230 may contain software application 234 and a content source such as data 236 for providing an optimized set of delivery locations for an order. Other software and content may be stored on storage 230 for sharing among various computer or other data processing devices. Client 240 may include software application 244 and data 246. Laptop 250 and mobile phone 260 may also include software applications 254 and 264 and data 256 and 266. Delivery vehicle 270 and facility 280 may include software applications 274 and 284 as well as data 276 and 286. Other types of data processing systems coupled to network 210 may also include software applications. Software applications could include a web browser, email, or other software application for providing an optimized set of delivery locations for an order.

Facility 280 may include lockers 288 for storing delivered packages for pick-up. Lockers may be small locked bins for storing packages until a code number is entered or other means used to provide access to an authorized person such as the person that purchased the package. Lockers may also be a storage area manned by a person responsible for verifying the identity of a person picking up the package and then providing the package from the storage area. Lockers may be climate controlled or have some exposure to the elements such as temperature and humidity. Lockers may be contained in a business, a governmental building or structure, a structure specific to that purpose, etc.

Server 220, storage unit 230, client 240, laptop 250, mobile phone 260, delivery vehicle 270 and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260, delivery vehicle 270 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

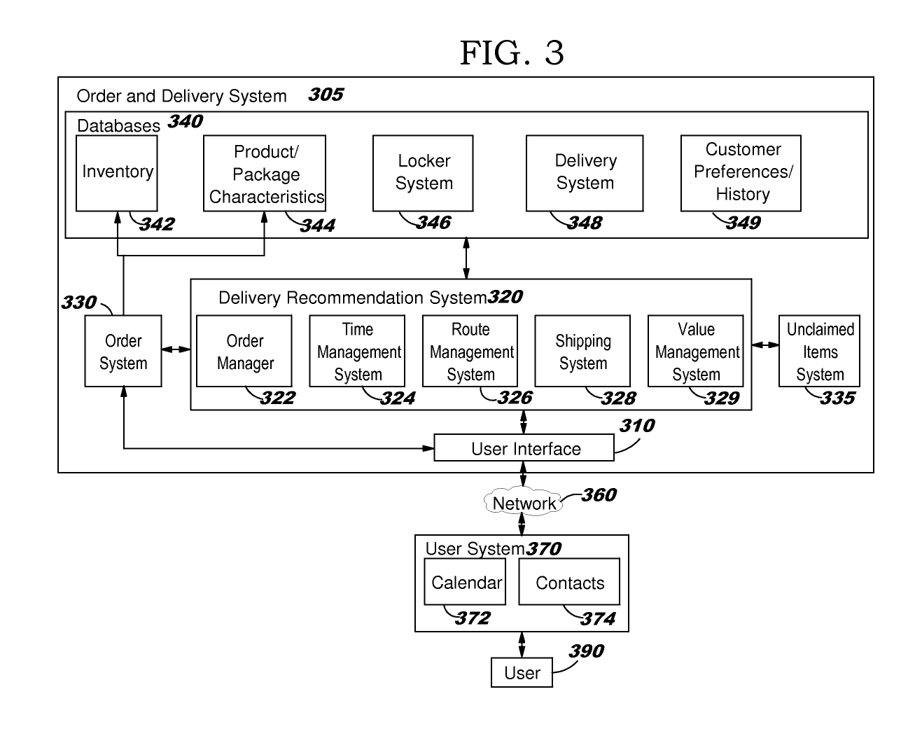

FIG. 3 is a block diagram of a delivery location optimizer system in which various embodiments may be implemented. An order and delivery system 305 communicates across a network 360 with a user system 370 for allowing user 390 (also referred to herein as a customer) to order products for delivery. Order and delivery system 305 may be implemented on a single server, multiple servers or even in a cloud implementation. Network 360 may be the internet or other communication network. User system 370 may be a desktop computer, laptop, tablet, smart phone, or other user communication device.

Order and delivery system 305 includes a user interface 310, a delivery recommendation system 320, an order system 330, an unclaimed items system 335, and databases 340. User interface 310 communicates with user system 370 across network 360. User interface 310 also communicates with delivery recommendation system 320 in providing information about shipping locations to user 390. Delivery recommendation system 320 communicates with order system 330 for each user or customer order. Delivery recommendation system 320 also utilizes databases 340 to provide optimized deliver locations through user interface 310, including offering multiple delivery locations in navigationally proximate locations. That is, a location is considered navigationally proximate if a customer can be reasonable expected to pick up an item from a delivery location with limited effect to the user's expected route. That location can also be navigationally proximate if a delivery vehicle can be reasonably expected to deliver items to that location within an expected schedule of deliveries. Route management system 326 can be utilized to determine whether two or more customers are navigationally proximate and therefore capable of combining delivery of their items to a single delivery vehicle.

Order system 330 may communicate directly with the user through user interface 310 and user system 370 in generating the order. Order system 330 may also communicate directly with inventory database 342 for receiving information about an order item and product/package characteristics database 344 for determining shipping characteristics and storage requirements of the packaging for items ordered. Order system may then provide information regarding an order to delivery recommendation system 320 for receiving delivery recommendations. The order information includes a list of the items ordered, which product sources (e.g., warehouses) in the vicinity of the delivery area have the ordered items in stock, packaging characteristics including package size and weight, any environmental restrictions such as temperature and humidity requirements (i.e. climate controlled requirements), the value of the items for determining security requirements, and whether any of the items are certain security restrictions based on the type of item (e.g. alcohol, medicines, etc.) that may also necessitate security requirements. Much of this information is gathered from inventory database 342 and product/package characteristics database 344 by order system 330. In an alternative embodiment, delivery recommendation engine may obtain this information from those databases directly. There are many types of on-line order systems utilized today to meet a wide range of application as known to those of ordinary skill in the art.

Unclaimed items system 335 is a system for handling packages not picked up by the customer. The unclaimed packages may be left at the locker for a period of time to allow the user to pick it up on another day, left at the locker if another customer navigationally proximate to the customer can be found to purchase the item, it may be returned to the source (e.g., warehouse) and shipped to a different locker on another day for pick up by the customer, or returned to the warehouse and a refund provided to the customer with a return fee assessed. Unclaimed items systems 335 handles these various scenarios.

Delivery recommendation system 320 includes an order manager 322, a time management system 324, a route management system 326, a shipping system 328 and a value management system 329. Order manager 322 manages each order delivery recommendations including utilizing the other modules of delivery recommendation system and databases 340 to provide a set of recommended delivery locations to user 390 and accepting the user choice of delivery location.

Time management system 324 determines the timing constraints involved in making delivery recommendations. This includes identifying the delivery constraints of the user in placing the order (e.g. the user requested next day delivery). This also includes, with user approval, checking the user's calendar and if needed contact information to determine the user's timing constraints for the expected date or time of delivery. For example, if the user is at his or her place of business the next day as indicated by scheduled meetings, then the ordered item(s) can be delivered to a nearby locker for pickup by the user during a break or at the end of work. Location information for appointments on the day of a delivery can also be obtained directly from the user through user interface queries. Certain user preferred route information may also be stored in customer preferences database 349 as well as identifying others that may do a pickup and their routes. In the case of large item deliveries (e.g., a safe), the user may be queried about the vehicle the user uses to pick up the delivery. If the user does not have a sufficiently large vehicle, then perhaps delivery should be made directly to the home of the customer.

Route management system 326 is able to take the timing constraints (and locations) identified by timing management system 324 and generate an expected route for the user. Route management system 326 is also able to take the delivery constraints and the expected delivery routes for that day and determine a set of lockers that are navigationally proximate to the expected user route and one or more of the expected delivery routes. Shipping system 328 utilizes the shipping requirements for the ordered items to determine whether any of the expected delivery routes and lockers meets the needs of the ordered items. This can include a variety of factors including size, weight, environmental concerns (e.g., temperature or protected from rain), safety concerns (e.g., the package is valuable and needs to be signed for), special considerations such as verifying that the person picking up the package is over 21 if the item is alcohol, etc.

After the order manager determines which delivery routes and lockers which meet the timing, delivery and shipping requirements for the seller and user, value management system 329 can then rank the lockers based on several weighted criteria to determine the greatest value to the user and/or the seller. This includes the costs of any special packaging and delivery requirements, any insurance and liability constraints, any savings from delivering multiple packages to the same customer at the same location, the cost model for each locker, etc. This is an optimization system which can make ranking recommendations based on factors such as minimizing costs, maximizing the probability of a successful delivery, increase the speed of delivery, etc. These factors may differ based on user as well as seller preferences.

Delivery recommendation system 320 utilizes databases 340 located in delivery location optimizer system 305 for assisting in making delivery recommendations. These databases store information utilized by delivery recommendation system 320. These databases include an inventory 342, product/package characteristics 344, locker system 346, delivery system 348, and customer preferences/history 349. Inventory 342 includes a current list of all products available. This is important to avoid recommending delivery of items for scheduled delivery that are not in stock. Inventory 342 can include information whether an item is available for sale or has been sold but is still in inventory awaiting selection for preparation and delivery to a customer. Inventory 342 can also provide the location of products for packaging and delivery such as the location of any sources (e.g., warehouses) in the vicinity that have an available product.

Product/package characteristics 344 include any shipping characteristics and storage requirements of a product and its packaging that could affect delivery and locker choice. These shipping characteristics can include size and weight of the item when packaged, value environmental concerns (e.g., temperature or protected from rain), safety concerns, security concerns, insurance and liability concerns, etc. These storage requirements can include regulations, signature requirements, security requirements, compliance rules, environmental concerns, etc. For example, medicinal products may have certain temperature and humidity constraints and may need the user to sign or otherwise verify his or her identify when obtaining the product. This can include a climate controlled delivery vehicle and a climate controlled locker with a person managing the locker area to verify the identity of the user. Alternatively, the user may be given a code for opening the climate controlled locker, thereby providing identity verification automatically.

Locker system 346 includes a location and description of any lockers available for receiving delivered packages. This includes any size and weight restrictions, any environmental restrictions or capabilities such as whether the locker is climate controlled (possibly with parameters of the climate control), a cost model for usage of the lockers, and any special services available to comply with any regulatory or other needs such as whether there is an attendant to the lockers, whether the lockers can only be opened with a code, etc. Costs models for lockers may vary depending on the location. For example, some lockers may have a low costs due to the business with the lockers desiring additional foot traffic, Other lockers with climate control and special services may charge more due to the costs of providing those capabilities. There may also be special discounts for employees of the locker owner or other special considerations. Some lockers have regular deliveries from delivery vehicles at regular times. If so, the delivery vehicles and their delivery times at the locker are also stored in this database.

Delivery system 348 includes a list of delivery vehicles, their capabilities and expected routes. Delivery vehicle capabilities include the size and weight restrictions of the delivery vehicle as well as any other capabilities such as climate control. Also included are the expected routes of the delivery vehicles including locker locations visited and expected delivery times for each location. This allows for identifying which routes may be useful for delivery packages to coincide with the user's expected travel route the day of delivery.

Customer preferences/history 349 includes a variety of information about the user including home location, business location, prior delivery information, etc. which can also be useful for determining the user's expected route as well as preferences regarding delivery timing and location. For example, the user may prefer that the product be delivered prior to 5 p.m. to a locker navigationally proximate to a route between the user's place of business and home. This may be a specific location such as near a grocery store or any location conveniently near the expected travel route. Certain user preferred route information may also be stored in customer preferences database 349 as well as identifying others that may do a delivery pickup and their routes.

Alternative embodiments may utilize alternative database configurations. For example, delivery recommendation system 320 may include additional software modules or a single software module for performing multiple functions. Delivery recommendation system 320 may also be combined with user interface 310. Databases 340 may be combined in alternative configurations, such as separating purchase history and user preferences 349 into two separate databases. Additional or different information may be collected and stored for use in each database.

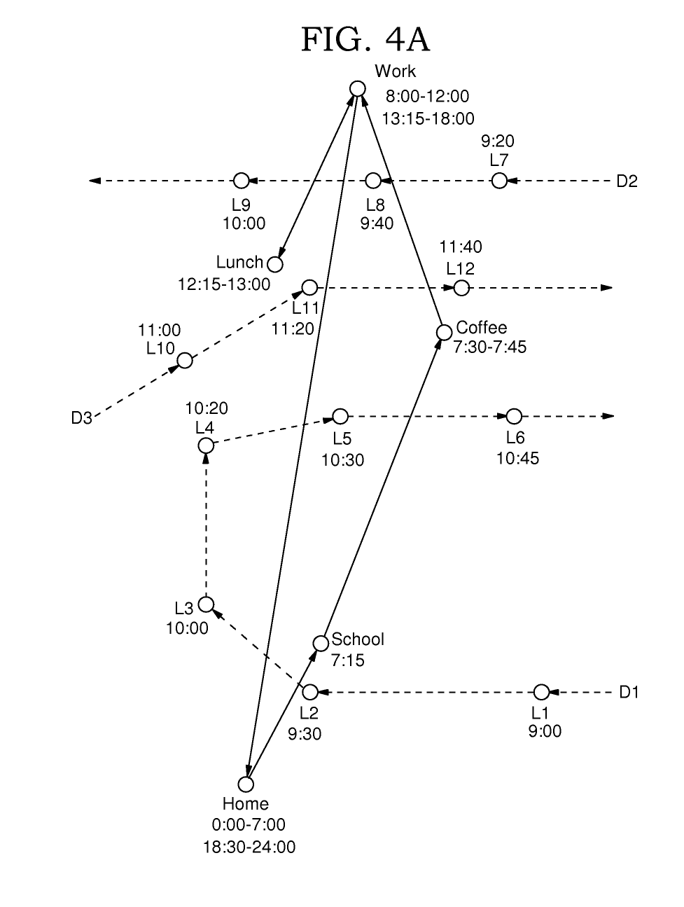

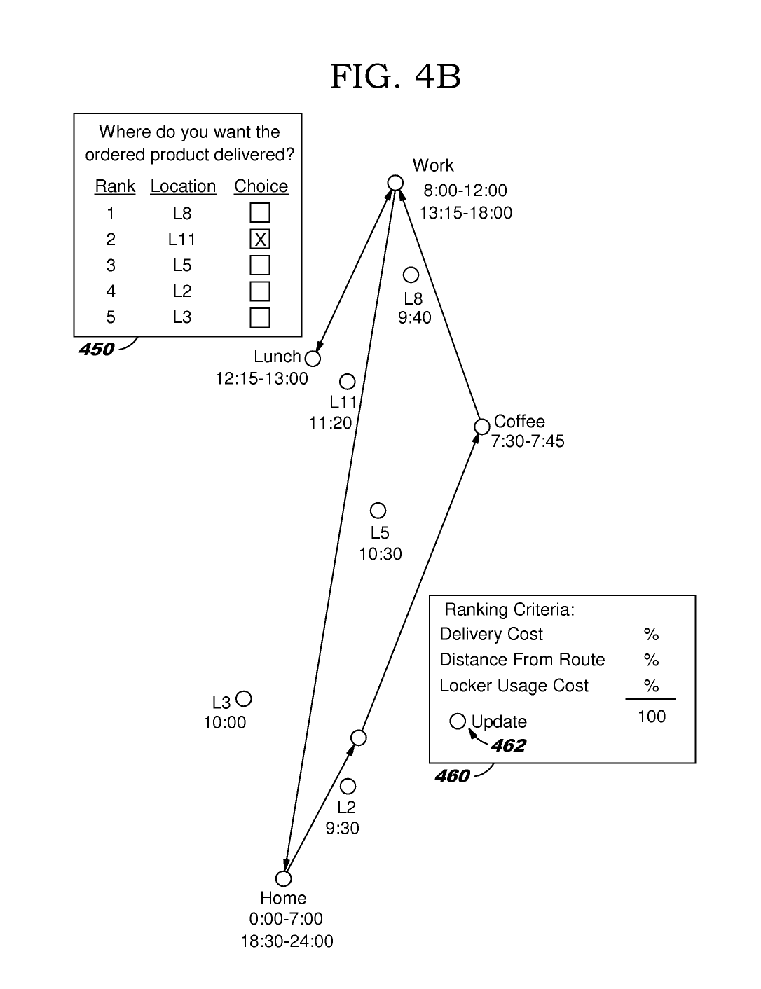

FIG. 4A is a diagram of a customer route and delivery vehicle routes in which various embodiments may be implemented. FIG. 4B is a diagram of a user interface for displaying and choosing from the ranked delivery locations in which various embodiments may be implemented. For illustrative purposes, these diagrams are shown without an underlying map, but can be easily configured on a map.

In the example shown in FIG. 4A, the customer route is a solid line with arrows showing the direction of travel between points with the time range the customer is at each location. Also, the delivery vehicle routes D1, D2 and D3 are shown with dotted lines with arrows in the direction of travel to lockers L1 through L12 with the delivery time at each locker. Lockers L1 through L12 are the lockers in the vicinity of the customer's route for the day of delivery. As may be inferred from the drawing, there may be two warehouses with the ordered product. Delivery vehicle D1 is traveling a circular delivery route from and back to the first warehouse, delivery vehicle D2 is traveling a delivery route from the first warehouse to the second warehouse, and delivery vehicle D3 is traveling a delivery route from the second warehouse to the first warehouse.

There are 12 choices for delivering the ordered product to a locker in this example. Assuming there are no special requirements or considerations, the primary considerations for ranking these lockers is whether the product is delivered before the customer travels near that locker, whether the locker is navigationally proximate to the customer's route, the closeness of the locker to the customers route, and any pricing or other considerations. In this example, none of the lockers will have the product delivered when the customer is on the way to work, so those lockers closest to the customer's lunch appointment route or the travel home from work route are the most likely candidates. Assuming there is no or minimal cost differential between lockers and that proximity to the customer's route is the primary consideration, then lockers L2, L3, L5, L8 and L11 are the closest to the customer's lunchtime or evening route. Ranking by proximity to the customer's lunchtime or evening route, with the closest ranked first, are L8, L11, L5, L2 and L3.

This ranking can be provided to the customer as shown in FIG. 4B for the customer to choose by selecting a desired location through the user system. The customer route is shown which allows the customer to make modifications to that route if needed. The delivery vehicle routes are not shown as that is not important to the customer. However, the locker locations and time of delivery to those lockers is shown. Cost differentials between the lockers may also be shown. The ranking of lockers is shown in window or pop-up box 450 which allows the customer to select one of the lockers for delivery. The criteria used for determining this ranking may be shown in box 460. This box can also allow the user to modify the criteria weighting by inserting different percentages and then pressing an update button 462 with a mouse. In such as case, the lockers rankings in box 450 will be recalculated and displayed. The customer may choose L11 over L8 because there may be more free time when traveling for lunch than when leaving work for home. Alternative embodiments may display the ranked lockers on the map in their ranked order, without a map, in a calendar format, or just as a listing with addresses. The selection of the ranked lockers may be determined by the customer clicking on the locker location on the map, by voice command, or a variety of other methods such as can be utilized by one of ordinary skill in the art.

Many other considerations and requirements may be taken into account. For example, certain lockers may not meet delivery requirements such as climate controlled or the need for an attendant to verify the customer's identity. As a result, those lockers would be excluded from the choices provided to the customer. Also, the second warehouse may not have the product in stock, so only delivery routes D1 and D2 and their corresponding lockers are considered. Furthermore, delivery vehicle D2 may already be full with scheduled deliveries so that route and the corresponding lockers may not be considered. Many other issues and constraints could affect the lockers ranked as well as the ranking of those lockers.

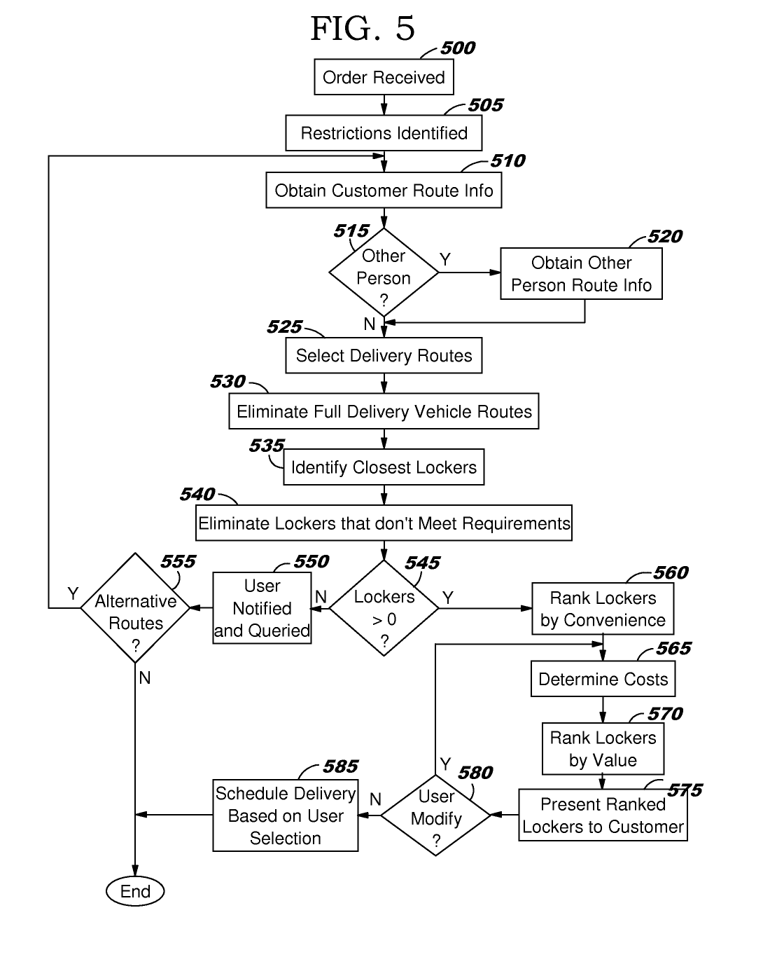

FIG. 5 is a flow diagram of providing delivery location recommendations in accordance with a preferred embodiment. In a first step 500, an order of products selected by a customer with a requested delivery date or dates has been obtained. This can include an address if the user is not at a normal location already stored in user preferences. For example, if the user if traveling, the user may want a delivery in the location where the user will be located at the time of delivery. The address may be specific or as general as a city name. In response to the user order, a set of delivery locations needs to be recommended to the customer for customer selection. This set of locations should be optimized based on a set of restrictions and criteria and ranked accordingly.

In a second step 505, any restrictions on delivering the items are identified. This includes identifying the size and weight of the ordered items when packaged and determining whether there are any specific delivery restrictions with the items ordered. For example, medicines or alcohol may have controlled environment requirements as well as verification requirements for the person picking up, the delivered packages. These restrictions may also be caused by the value of the items ordered (e.g. jewelry) as well as legal restrictions (e.g. alcohol). These restrictions or requirements can be obtained from any user preferences provided in the order, prior customer preferences stored in a user preference database, and a product/package characteristics database.

In a third step 510, activity information regarding the customer's address or route including expected timing during the requested day of delivery is gathered. A route can include a single address such as if the user's activities during the day of delivery are all located that that single address. There can be more than one customer address such as home address, work address or even travel address. This customer activity information including expected timing can be obtained directly by the customer during the order process, from a user preferences database, or from information accessible with permission on the customer's system or elsewhere such as calendaring information. The calendar can include the time the customer will be at a certain location or meeting with a specific person. If this information is not available in the calendar or its metadata, then contact information located on the customer's system or other accessible activity information with expected timing may also be accessed with permission. The customer's route with expected timing can be generated from this activity information by a time management system with a route management system.

In step 515, it is determined whether any other person may be authorized by the first user for picking up the delivery instead of the customer. If not, then processing continues to step 525, otherwise processing continues to step 520. In step 520, since another person besides the customer authorized by the first user may be picking up the package, then similar information can be obtained about the other person such as from the other person directly or that person's system with permission. The route information of other person picking up the ordered items can be generated from this information by a time management system with a route management system. In an alternative embodiment, the determination whether another person may be picking up the ordered items can be determined prior to step 510. However, it is also very likely that either person may pick up the ordered items, depending on user preferences. The below is further described with reference to the customer picking up the ordered items, although the processes could also apply to another person picking up the ordered items. Processing then continues to step 525.

In step 525, relevant warehouse and delivery vehicle information is obtained and selected for identifying possible lockers for delivery of the ordered items. This includes using inventory database information, delivery system information, and the general location of the customer (or other pick up person) address and route. That is, only those warehouses and delivery routes in the vicinity of the customer or other person route are considered unless the ordered item is not located in any nearby warehouses. In such a case, the time needed to ship the item from a remote warehouse or manufacturer to the local warehouse needs to be considered. Then in step 530, any delivery vehicles already full and (unable to deliver the ordered items on the requested delivery day) or can't meet the shipping characteristics of the ordered items are eliminated from consideration as well as any lockers that are solely serviced by those routes. For example, two routes may service the same locker. If one of those routes is eliminated and the other route can be utilized to deliver the ordered item to that locker in a timely manner, then that locker is not eliminated from consideration.

In step 535, those lockers closest (navigationally proximate) to the customer's address and route (or other person picking up the ordered items) are identified where a delivery can occur prior to the customer being in the area of the locker. These lockers are identified from the set of lockers located on delivery vehicle routes of step 525 and not eliminated in step 530. A shipping system such as described above can perform such a matching algorithm. Then in step 540, any lockers that don't meet the storage requirements of the ordered items are eliminated. For example, if a locker is not climate controlled as required by the ordered products, then that locker is eliminated from consideration. Steps 535 and 540 may be performed in a reverse sequence.

In step 545, it is determined whether there are any lockers remaining for consideration. If not, then in step 550 the user is notified and queried whether the items should be delivered to the user's address or if the user has any alternative routes or delivery dates to consider. In step 555, the user's response determines the next step. If an alternative address, route or delivery date is available, then processing returns to step 510 above, otherwise processing ceases on recommending delivery to a locker.

If there are lockers remaining for consideration in step 545, then in step 560 the lockers are ranked according to customer (or other person picking up the ordered items) convenience. This includes considering navigational proximity to the user's address and route. For example, a locker may be close to the user's route geographically, but there may be a river or other obstruction between them. As a result, travel time and other factors may be considered to determine navigational proximity. Other factors can include user preferences (e.g., prefer that lockers be between work and home addresses), and any other convenience factors that can be ascertained and quantified. The route management system can be utilized by the order manager to assist in this ranking.

In step 565, the costs of the proximity ranked lockers are then determined such as by a value management system using value ranking criteria. These value ranking criteria include delivery cost, convenience of picking up the item and delivering the item to the address, cost of usage of the locker, user preference, historical usage, end delivery date, etc. Then in step 570, the convenience and costs are weighed using the criteria including predetermined factors and user preferences to generate a final value ranking based on providing the greatest value for the customer and seller. This ranking can vary by application, in accordance with the predetermined factors and user preferences. For example, if the incremental difference between delivery costs is paid by the customer, then customer convenience will be heavily weighted. If the incremental difference between delivery costs is paid by the seller, then cost may be more heavily weighted.

Then in step 575, the value ranked lockers are presented to the customer for selection. The presentation of the lockers should include the time the items would be available at each location, the relative location of that locker to the customer's (or other person picking up the ordered items) address and route, any cost differentials to be paid by the customer, any requirements such as that an attendant will verify the identity of the person picking up the delivered items, etc. so that the customer makes an informed choice. The user has an option to modify certain value ranking criteria. For example, the user does not pay for certain costs, so those criteria may be weighted according to the wishes of the seller rather than the buyer. In step 580, it is determined whether the user has modified the ranking criteria. If yes, then processing returns to step 565, otherwise processing continues to step 585.

Finally, in step 585, when the user provides a selection, the delivery is scheduled including reserving space on the delivery vehicle on the delivery date.

Alternative embodiments may perform the same or similar steps in a different order. For example, full delivery routes may be eliminated before selecting delivery routes for consideration. Instead of ranking the lockers by convenience, a quantifiable convenience factor may be determined. In addition, other restrictions and requirements can be considered through the recommendation process depending on the circumstances.

In another alternative embodiment, the customer may order an item for delivery to a locker with a scheduled time the locker can be opened. For example, if a book is available for sale at midnight, then the book could be ordered, put in the locker, yet the locker cannot be opened by the customer until midnight. This allows for the book seller to increase such midnight sales and avoid certain crowd issues than can arise with a centrally located midnight book sale. This can be accomplished through a variety of embodiments such as giving the customer a code to the locker that does not work until midnight or emailing the code to the customer at midnight.

In a further alternative embodiment, the customer may select multiple lockers for delivering the ordered items. A customer may select this option where the customer is uncertain as to whether his or her planned route will be modified significantly on the delivery date. While there may be a restocking fee for the item or items not picked up, the customer has greater flexibility and can pick up the delivered items at any one of the selected lockers. This will require a lock out mechanism where once the ordered items are picked up at one locker, they cannot then be again be picked up at another location under the same order.

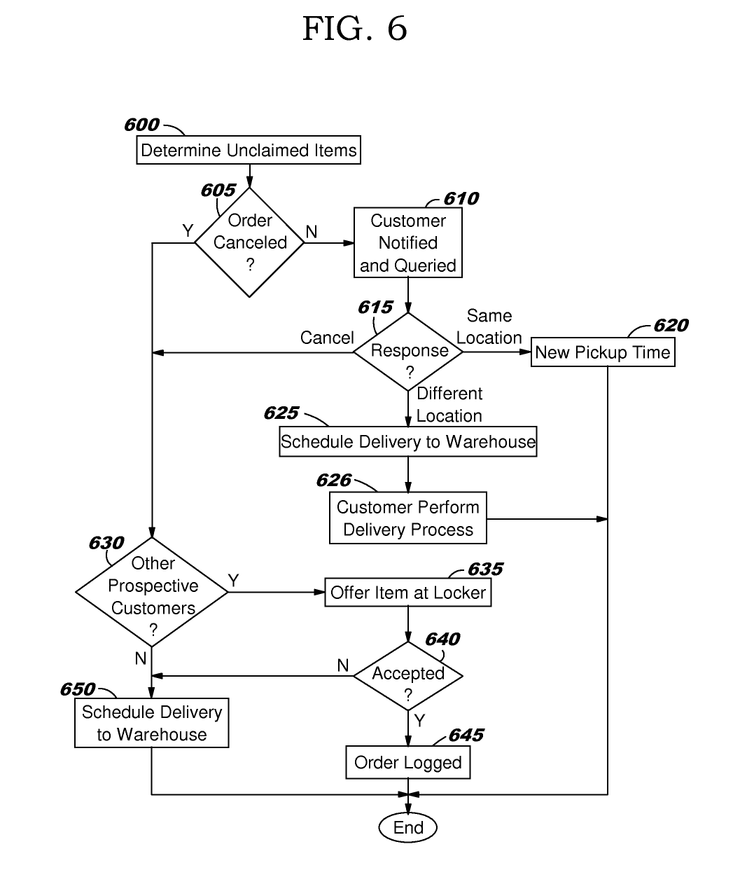

FIG. 6 is a flow diagram of handling unclaimed items in which various embodiments may be implemented. This can occur where the customer did not pick up an item as scheduled or in the case of a multiple locker delivery. In this case, several options can be pursued. In a first step 600, it is determined that one or more delivered items have not been picked up as scheduled. Then in step 605, it is determined whether the order has been cancelled. This may occur by the customer cancelling the order, by the customer requesting the ordered items be delivered to another location (which is essentially a cancelled order with a new order), or by the customer picking up the same ordered items at another location. If yes, then processing continues to step 630, otherwise in step 610 the customer is notified of the missed pick up and queried as to whether the customer wants to cancel the order, try to pick up the items again the next day at the same location, or have the items delivered to an alternative location. The response of the customer processed in step 615. If the customer cancels the order, then processing continues to step 630. If the customer wants to pick up the order the next day, then in step 620 that selection is logged in the appropriate databases and processing ceases. The customer may be charged a locker storage fee in this case. If the customer wants to have the items delivered to an alternative location, then in step 625 the delivered items are scheduled for delivery back to the warehouse and the customer is directed in step 626 to repeat the process described in FIG. 5 above for a new delivery date. The customer may be charged a redelivery fee in this case.

If the order has been determined to be cancelled in steps 605 or 615, then the product is located in a locker away from the warehouse. In step 630, it is determined whether there are one or more customers located or travelling in the vicinity of the locker who may be interested in purchasing the unclaimed item. If yes, then in step 635 the unclaimed items may be offered to those customers for a limited time, possibly with a discount or incentives. In step 640 is determined whether any offer has been accepted. If an offer is accepted, then in step 645 the order is logged in the appropriate databases and processing ceases. If there are no other potential customers identified in step 630 or if no offer is accepted in step 640, then in step 650 the unclaimed items are scheduled for pickup and delivery back to the warehouse, presumably by one of the delivery vehicles that regularly delivers to that locker. Processing then ceases.

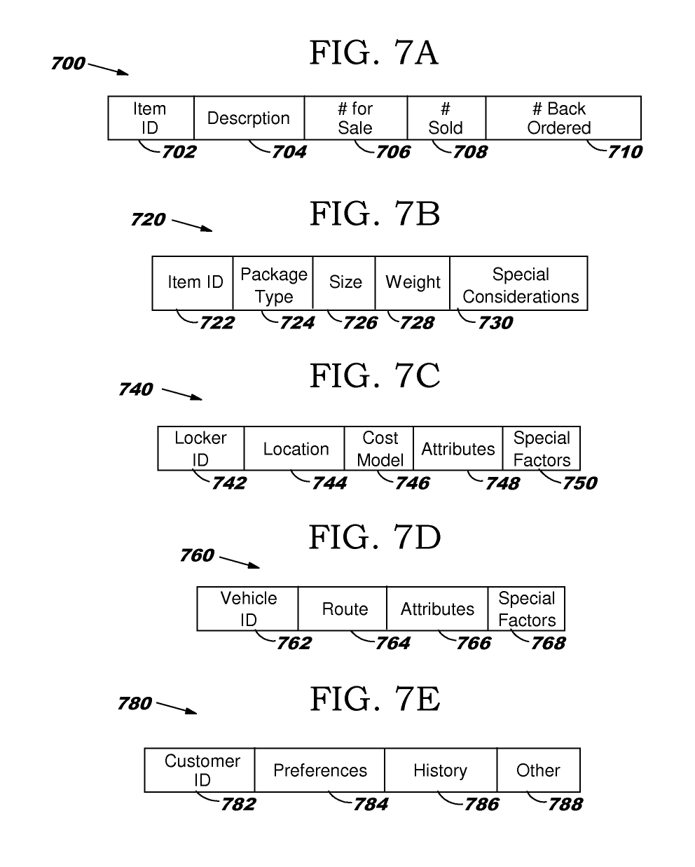

FIGS. 7A through 7E are block diagrams of types of database records in which various embodiments may be implemented. A record is a set of information within a domain or database that establishes a relationship between a set of data or data elements. A record may be a separate entry into a database, a set of links between data, or other logical relationship between a set of data. FIG. 7A is a block diagram of a record 700 stored in an inventory database for tracking items available for delivery. FIG. 7B is a block diagram of a record 720 stored in a product/package characteristics database for providing information regarding packaged items which may be delivered and which can be cross linked with the inventory database. FIG. 7C is a block diagram of a record 740 stored in a locker system database for describing lockers available for receiving deliveries. FIG. 7D is a block diagram of a record 760 stored in a delivery system database for use in identifying delivery vehicles and routes which can be utilized for delivering ordered items to lockers. FIG. 7E is a block diagram of a record 780 stored in a customer preferences/history database for use in providing information about customer (users). The records described below are examples and alternative embodiments may utilize other structures and types of data utilized for implementation.

FIG. 7A is a block diagram of a record 700 stored in an inventory database. There can be a single record for each item or class of items, although alternative embodiments may differ. For example, multiple items may be assembled into a single product so that there may be multiple records for an assembled item ordered. Each record includes an item identifier 702, an item description 704, a quantity of items available for immediate sale 706, a quantity of items sold but not delivered yet 708 and a quantity of items backordered 710. Additional information such as statistical information including average sales per time period, seasonal variations in sales, and minimum quantities before ordering more items may also be stored in this database.

FIG. 7B is a block diagram of a record 720 stored in a product/package characteristics database for providing information regarding packaged items which may be delivered and which can be cross linked with the inventory database. Record 720 includes an item identifier 722 which can be cross-linked to the inventory database, a package type 724 (e.g. envelope, box, pallet), size 726, weight 728 and special considerations 730. Special considerations 730 can include and shipping characteristics and storage requirements needed to determine whether a delivery vehicle or locker is able to ship or store the packaged item.

FIG. 7C is a block diagram of a record 740 stored in a locker system database for describing lockers available for receiving deliveries. Record 740 includes a unique locker identifier 742 to identify a locker or set of lockers. Also includes are the location 744, cost model 746 used for charging for locker usage, any locker attributes 748 such as locker storage capabilities to meet any package storage requirements, and any other special factors 750 which may be needed. For example, the delivery vehicles that deliver to the locker may be identified. Also, an inventory of which lockers are full or empty and available for delivery can also be stored in this database.

FIG. 7D is a block diagram of a record 760 stored in a delivery system database for use in identifying delivery vehicles and routes which can be utilized for delivering ordered items to lockers. There is generally one record for each delivery vehicle. Record 760 includes a delivery vehicle identifier 762 such as VIN, a route 764, vehicle attributes 766 and any special factors 768. Route 764 can specify a unique route that includes the route source (e.g., warehouse), lockers delivered to, and time of delivery. A route ID may also be stored instead as a reference to route information stored in a separate database. Vehicle attributes 766 include and shipping attributes of the delivery vehicle which can meet certain product shipping characteristics. Special factors 768 can include a variety of information including current shipping load showing the availability of the delivery vehicle to handle additional packages in a given route.

FIG. 7E is a block diagram of a record 780 stored in a customer preferences/history database for use in providing information about customer (users). Record 780 includes a unique customer identifier 782, any user or customer preferences 784, customer purchase and other history 786, and any other information 788 which may be useful. For example, a customer may have a preferred set of value criteria for ranking lockers for delivery. A customer may also have special preferences for lockers used for deliveries.

The invention can take the form of an entirely software embodiment, or an embodiment containing both hardware and software elements. In a preferred embodiment, the embodiments are implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for providing an optimized set of delivery locations for an order. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of recommending a delivery locker based on user convenience and delivery cost comprising:
receiving a request to deliver an item to a user;
utilizing a processor to analyze user activity information to identify a user route including expected timing;
utilizing the processor to analyze the item for storage requirements to identify lockers meeting the requirements which are navigationally proximate to the user route;
ranking the identified lockers with a ranking based on criteria; and
presenting an ordering of the identified lockers based on the ranking for user selection.

2. The method of claim 1 further comprising:
identifying a second user authorized by the first user for picking up the item;
analyzing the second user activity information to identify a second person route including expected timing; and
analyzing the item for storage requirements to identify lockers meeting the requirements which are navigationally proximate to the user route.

3. The method of claim 1 wherein analyzing user activity information includes analyzing user calendar and contact information.

4. The method of claim 1 wherein analyzing the item for storage requirements includes analyzing the item for shipping characteristics to identify delivery vehicles delivering to the identified lockers.

5. The method of claim 4 wherein the shipping characteristics are selected from a group consisting of source, size and weight of the item when packaged, value, environmental concerns, safety concerns, security concerns, and insurance and liability concerns.

6. The method of claim 1 wherein the storage requirements are selected from a group consisting of regulations, signature requirements, compliance rules, security requirements, and environmental concerns.

7. The method of claim 1 wherein the criteria are selected from a group consisting of delivery cost, convenience of picking up the item and delivering the item to the address, cost of usage of the locker, preference, historical usage, and end delivery date.

8. The method of claim 1 further comprising:
providing a user interface (UI) allowing a user to identify, adjust, and select the address, the others, and modify the criteria; and
responsive to the user utilizing the UI, adjusting the ranking based on user selections and presenting an updated ordering of the lockers based on the adjusted rankings

9. The method of claim 8 further comprising:
identifying a second user for picking up the item;
analyzing the second user activity information to identify a second person route including expected timing;
analyzing the item for storage requirements to identify lockers meeting the requirements which are navigationally proximate to the user route;
providing a user interface (UI) allowing a user to identify, adjust, and select the address, the others, and modify the criteria; and
responsive to the user utilizing the UI, adjusting the ranking based on user selections and presenting an updated ordering of the lockers based on the adjusted rankings;
wherein analyzing user activity information includes analyzing user calendar and contact information;
wherein analyzing the item for storage requirements includes analyzing the item for shipping characteristics to identify delivery vehicles delivering to the identified lockers; and
wherein the shipping characteristics are selected from a group consisting of source, size and weight of the item when packaged, value, environmental concerns, safety concerns, security concerns, and insurance and liability concerns.

10-20. (canceled)
